(19) United States
(12) Patent Application Publication
(10) Pub. No.: US 2025/0376263 A1
(43) Pub. Date: Dec. 11, 2025

(54) HYBRID BATTERY PACK FOR AN AIRCRAFT

(71) Applicant: Enpower Greentech, Inc., New York, NY (US)

(72) Inventors: Yang Wang, Ann Arbor, MI (US); Boyuan Liu, Ann Arbor, MI (US); Zhendong Hu, Ann Arbor, MI (US); Yong Che, Ann Arbor, MI (US)

(21) Appl. No.: 18/739,737

(22) Filed: Jun. 11, 2024

(51) Int. Cl. B64D 27/357; B60L 58/12; B60L 58/22; B60L 58/26; H01M 10/613; H01M 10/625; H01M 10/6567; H02J 7/00; H02J 9/06

(52) U.S. Cl. CPC B64D 27/357; B60L 58/12; B60L 58/22; B60L 58/26; H01M 10/613; H01M 10/625; H01M 10/6567; H02J 7/0024; H02J 9/06; B60L 2200/10; H01M 2220/20

(57) ABSTRACT

Disclosed is a hybrid battery pack designed for aircraft. The hybrid battery pack comprises a primary battery comprising battery cells having a high self-discharge rate (high K-value) for daily operation and an emergency battery comprising battery cells having a low self-discharge rate (low K-value) for emergency power. This hybrid battery pack addresses the trade-off between battery lifetime and weight, offering enhanced safety, reliability, and efficiency for aircraft.

### CROSS REFERENCE TO RELATED APPLICATIONS

None.

### FIELD OF THE DISCLOSURE

This disclosure relates generally to energy storage systems, and more particularly to a hybrid battery pack for an aircraft.

### BACKGROUND OF THE DISCLOSURE

This section provides background information which is not necessarily prior art to the present disclosure.

The field of electrical engineering, specifically battery storage systems, has seen significant advancements in recent years, particularly in the context of aerospace engineering. In commercial aviation, the safety and reliability of aircraft systems are of paramount importance, which is why backup electrical power systems are crucial. These systems are designed to provide sufficient power to essential aircraft systems in case of an emergency, ensuring that critical functions can continue for a specified duration. The Federal Aviation Administration (FAA) sets specific requirements for the duration of aircraft backup electrical power systems, which is 30 minutes for an aircraft certified to a maximum altitude of 25,000 feet and an hour for aircraft certified to a maximum altitude of greater than 25,000 feet. In addition, the industry is developing aircraft that are fully electrified wherein the engines and all systems are electric to reduce dependence on fossil fuels.

Aircraft that use fossil fuels typically include onboard batteries that are used to power various systems during normal takeoff, flight, and landing. To meet the FAA backup electrical power system duration requirements in a typical aircraft these onboard batteries are not fully discharged during the normal uses described above. Instead of being fully depleted during normal operations, a reserve of battery energy is maintained in the onboard battery in case of an emergency. This reserve acts as an emergency buffer, ensuring essential aircraft systems have electrical power in the event of an unexpected failure. An energy management system monitors the onboard battery's state to ensure that the emergency reserve remains available throughout a flight. Fully electric aircraft also required primary batteries for use during takeoff, flight and landing and backup batteries for emergency situations.

Despite the advancements in battery technology, there are still several challenges and limitations that need to be addressed. One of the main issues is the trade-off between the battery cycle lifetime and their weight. Batteries with a long cycle life, meaning the number of charge and discharge cycles the battery can complete before losing performance, can support the aircraft's daily normal operations but are generally too heavy if built large enough to also include an energy reserve for extended emergency backup periods. On the other hand, batteries with a slow self-discharge rate and high gravimetric energy density can be light weight, however, they may not be suitable for use during daily normal operations due to their limited cycle life. These concerns are especially amplified in fully electric aircraft since their battery needs are generally higher than a typical aviation fuel aircraft. Additionally, the maintenance cost of backup batteries, including frequent checks on their charge status and necessary recharging, is another significant concern. Furthermore, the additional weight of the backup battery contributes to the overall operational cost.

### SUMMARY OF THE DISCLOSURE

This section provides a general summary of the present disclosure and is not intended to be interpreted as a comprehensive disclosure of its full scope or all features, aspects, and objectives.

Disclosed herein is a hybrid battery pack for an aircraft, comprising: a primary battery comprising a first plurality of battery cells having a first self-discharge rate (a first K-value); and an emergency battery comprising a second plurality of battery cells having a second self-discharge rate (a second K-value), wherein the second K-value is less than the first K-value.

### BRIEF DESCRIPTION OF THE DRAWINGS

The drawings described herein are for illustrative purposes only of selected aspects and not all implementations, and are not intended to limit the present disclosure to only that actually shown. With this in mind, various features and advantages of example aspects of the present disclosure will become apparent to one processing ordinary skill in the art from the following written description and appended claims when considered in combination with the appended drawings, in which:

FIG. 1 is a graph that shows the self-discharge rate of three different battery cells made with different types of anode material;

FIG. 2 is a graph illustrating the reduced weight of two hybrid battery packs compared to a conventional battery pack;

FIG. 3 is a schematic illustration of a hybrid battery pack structure designed in accordance with an embodiment of the present disclosure;

FIG. 4 is a flow chart of an embodiment of a voltage control protocol during an emergency situation; and

FIG. 5 schematically illustrates an aircraft power system with a hybrid battery pack designed according to one embodiment of the present disclosure.

### DETAILED DESCRIPTION OF THE DISCLOSURE

In the following description, details are set forth to provide an understanding of the present disclosure.

For clarity purposes, example aspects are discussed herein to convey the scope of the disclosure to those skilled in the relevant art. Numerous specific details are set forth such as examples of specific components, devices, and methods, to provide a thorough understanding of various aspects of the present disclosure. It will be apparent to those skilled in the art that specific details need not be discussed herein, such as well-known processes, well-known device structures, and well-known technologies, as they are already well understood by those skilled in the art, and that example embodiments may be embodied in many different forms and that neither should be construed to limit the scope of the disclosure.

The terminology used herein is for the purpose of describing particular example aspects only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or feature is referred to as being “on,” “engaged to,” “connected to,” “coupled to” “operably connected to” or “in operable communication with” another element or feature, it may be directly on, engaged, connected, or coupled to the other element or layer, or intervening elements or features may be present. In contrast, when an element is referred to as being “directly on”, “directly engaged to”, “directly connected to”, or “directly coupled to” another element or feature, there may be no intervening elements or layers present between them. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly and expressly indicated by the context. Thus, a first element, component, region, layer, or section discussed below could be termed a second element, component, region, layer, or section without departing from the teachings of the example embodiments.

For purposes of description herein, the terms “upper”, “lower”, “right”, “left”, “rear”, “front”, “vertical”, “horizontal”, and derivatives thereof shall relate to the invention as oriented in the FIGS. However, it is to be understood that the present disclosure may assume various alternative orientations and step sequences, except where expressly specified to the contrary. It is also to be understood that the specific devices and processes illustrated in the attached drawings, and described in the following specification are exemplary aspects of the inventive concepts defined in the appended claims. Hence, specific dimensions and other physical characteristics relating to the aspects disclosed herein are not to be considered as limiting, unless the claims expressly state otherwise.

As noted above, the disclosed hybrid battery pack will find use in both typical aviation fueled aircraft and in newly developed fully electric aircraft. In both types of aircraft there are primary batteries used during takeoff, flight, and landing and a need for emergency backup batteries for use in case of an emergency. Clearly, a fully electrified aircraft wherein all of the motors and systems are electric and no aviation fuel is used has a higher battery need than a typical aircraft. The disclosed hybrid battery pack finds use in both types of aircraft and the term “aircraft” when used herein is intended to mean both types of aircraft unless a specific distinction is made between them.

The hybrid battery pack disclosed herein offers a novel solution to the challenges faced by traditional backup power systems in aircraft. The disclosed hybrid battery pack combines two types of battery cells into a single hybrid battery pack to overcome the shortcomings of the batteries currently used in aircraft. The two types of battery cells have complementary characteristics with a first plurality of battery cells having a higher self-discharge rate and a longer cycle life while a second plurality of battery cells have a lower self-discharge rate, a shorter cycle life, and a higher gravimetric energy density. The hybrid battery pack achieves an optimal balance between weight, energy storage capacity, and operational lifespan. The operation of each type of cell is controlled by one or more battery management systems, dynamically allocating power for normal daily aircraft operations and for emergency backup scenarios. This innovative approach enhances aircraft safety, reliability, and efficiency while minimizing operational costs.

The first plurality of battery cells, having a higher self-discharge rate and a longer cycle life, are designed for daily use and can be cycled between 0 and 100% state of charge (SOC). The first plurality of battery cells forms a primary battery that is used during daily operations. The self-discharge rate of a battery cell is quantified as its K-value as described herein. The second plurality of battery cells with a low self-discharge rate, are designed to be used for emergency backup electrical power. This second plurality of battery cells forms the emergency battery that is used only during emergencies. Together the primary and emergency batteries form the hybrid battery pack according to the present disclosure.

For daily operation, although high gravimetric energy density is crucial to maximize range and payload capacity, commercial aircraft also require batteries with a high cycle life during takeoff and landing, which demand significant power, especially for fully electrified aircraft. Batteries balanced between the gravimetric energy density, cycle life and high power generally have high self-discharge rates.

On the other hand, the backup electrical power system only operates during emergency cases which are quite rare and thus this system needs a battery with a longer stored charge time and more tolerant cycle life. Therefore, batteries with a low self-discharge rate and potential high gravimetric energy density are ideal.

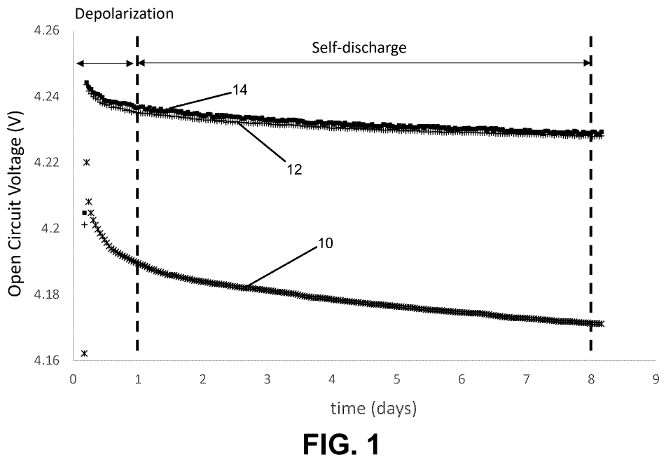

The self-discharge rate of a battery cell is physically quantified by the K-value. It is calculated by dividing the open circuit voltage (OCV) difference between two tests by the time interval ΔT between the two tests. Thus, the formula for calculating the K-value of a battery cell is OCV₂−OCV₁/ΔT, where ΔT is the time period between the measurement of OCV₁ and OCV₂. The higher the self-discharge rate is, the larger the K-value will be. As an example, FIG. 1 shows the self-discharge rate for three different battery cell types. The OCV in volts of each cell type is plotted against the time of measurement. As known to one of skill in the art, during an initial phase after charging, in this example it was approximately 1 day, a lithium battery cell goes through a “relaxation” phase, labeled as “Depolarization” in FIG. 1, wherein it initially self-discharges at an accelerated rate, it then settles into the actual equilibrium self-discharge rate as shown in FIG. 1 in the section labeled as “Self-discharge”. All of the lithium battery cells shown in FIG. 1 had a cathode made of 80% nickel, 10% manganese, and 10% cobalt (NMC or NMC811). The difference between the battery cells was the anode material. The line 10 was from a lithium battery cell with an anode of graphite, line 12 was from a lithium battery that was “anode free”, and line 14 was from a lithium battery with an anode of lithium metal. As known to one of skill in the art an “anode free” lithium battery cell is one wherein the battery cell is initially formed without an anode active material, instead it has an anode current collector. The first time the battery cell is charged it creates its own anode on the current collector, in the example shown in line 12 the anode was created from a copper current collector. Suitable current collectors for anode-free battery cells can comprise copper, titanium, aluminum, nickel, and stainless steel. Generally, battery cells having graphite or silicon anodes show much higher K-values compared to other anodes. The results in FIG. 1 clearly show the Li metal anode 14 or the anode free 12 cells have significantly lower self-discharge rates, K-values, compared to graphite anode cells when all are paired with NMC cathodes. The calculated K-values were 1.344, 0.576 and 0.528 mV/day for the graphite anode, the lithium metal anode and anode-free cells, respectively.

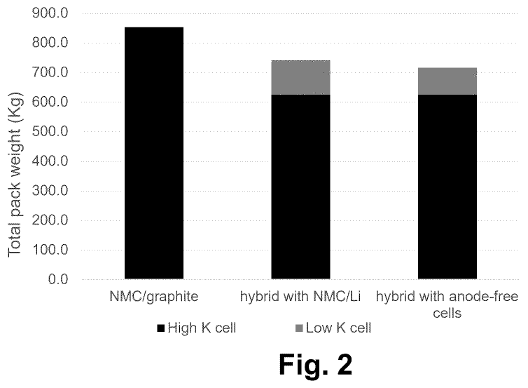

As disclosed herein, in the hybrid battery pack a combination of high and low self-discharge battery cells will ensure that the backup electrical power system is always ready for use in case of an emergency. The high self-discharge rate battery cells in the primary battery are for daily use in the aircraft while the low self-discharge rate battery cells in the emergency battery are for emergency use. The disclosed hybrid battery pack, containing the primary battery and the emergency battery, also has a reduced total battery pack weight, the reduction will allow for additional passengers or passenger baggage to be accommodated. In the examples displayed in Table 1 below and in FIG. 2, the total battery pack energy of each battery pack was fixed at 150 kWh and 20% of this energy is reserved for emergency uses. In the examples the total battery cell weight to total battery pack weight is set at 80% and typical gravimetric energy density values for graphite anode, lithium metal anode and anode-free cells were adopted. The total battery pack weight includes the weight of the battery cells, the structural members, the outer casing and all the other components of the battery pack. The example of NMC/Graphite cells is a battery pack with a single battery cell type design, all NMC/Graphite battery cells for daily use and for emergency use, wherein all the battery cells have a high self-discharge rate and a portion of the overall energy of the battery pack is reserved for emergency use. In these battery cells the cathode is NMC and the anode is graphite and they all have a high K-value. The hybrid battery packs designed in accordance with the present disclosure result in a significant weight savings without any compromise in performance. The total pack weight decreases by 111.0 kg in a hybrid battery pack that combines a first plurality of NMC/Graphite battery cells with a high K-value and a second plurality of NMC/lithium metal battery cells with a low K-value. The NMC/Lithium battery cells have a cathode of NMC and an anode of lithium. If the hybrid battery pack is designed with a first plurality of NMC/graphite battery cells with a high K-value and a second plurality of NCM/anode-free battery cells with a low K-value, the total weight decreases significantly by 136.4 kg. These battery cells have a cathode of NMC and an anode-free design with a copper current collector. Thus, the combination of high K-value battery cells with low K-value battery cells results in a hybrid battery pack that has more functionality, a higher gravimetric energy density and a reduced overall weight. The K-values in Table 1 are for the cells comprising NMC/Graphite, NMC/lithium, or NMC/anode-free cells, not for the entire hybrid battery pack.

TABLE 1

| | NMC/ | Hybrid battery | Hybrid battery |
|---|---|---|---|
| | Graphite | pack NMC/ | pack NMC/Anode |
| Parameter | cells | Lithium cells | Free cells |
| K-value (mV/day) | 1.344 | 0.576 | 0.528 |
| Total battery pack | 150 | 150 | 150 |
| energy (kWh) | | | |
| Emergency energy | 40 | 40 | 40 |
| (kWh) | | | |
| Cell gravimetric | 220 | 430 | 500 |
| energy density (Wh/kg) | | | |
| Total cell weight of | 625 | 625 | 625 |
| high self-discharge | | | |
| cells (kg) | | | |
| Total cell weight of | 227.3 | 116.3 | 100.0 |
| emergency cells (kg) | | | |
| Total battery pack | 852.3 | 741.3 | 725.0 |
| weight (kg) | | | |
| Weight reduction | 0 | 111.0 | 136.4 |
| compared to NMC/ | | | |
| graphite (kg) | | | |

As shown graphically in FIG. 2 the hybrid battery packs comprising NMC/Graphite battery cells with either NMC/Lithium battery cells or NMC/anode-free battery cells are significantly lighter in weight for the same energy capacity compared to the all NMC/graphite battery pack, with the anode-free battery cells being the most energy dense of the two hybrid battery packs.

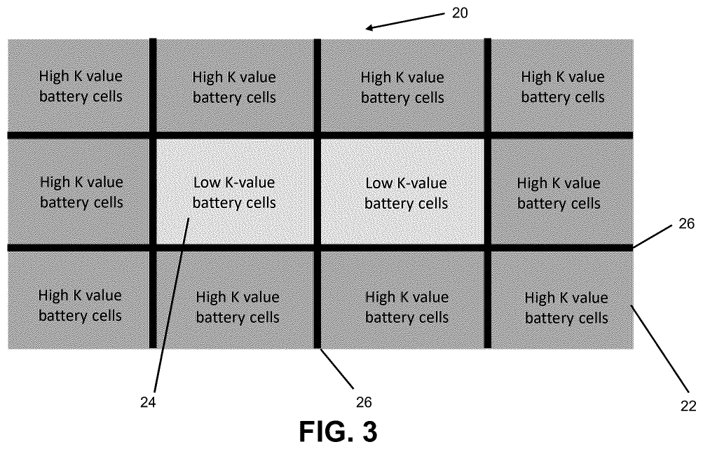

When designing the structural layout of a hybrid battery pack that incorporates high K-value and low K-value battery cells, there are several considerations to ensure high mechanical strength while accommodating the differences between the battery cell types. The whole hybrid battery pack layout should also facilitate efficient heat dissipation, especially considering that high K-value cells will undergo regular cycling which generates heat. An example of one hybrid battery pack design is shown schematically generally at 20 in FIG. 3. For ease of discussion the hybrid battery pack 20 is shown without an outer casing. In general, heat dissipation is more efficient along the edges of a battery pack as compared to in the center of the battery pack. Therefore, in the hybrid battery pack 20 the plurality of low K-value battery cells 24 are preferably placed in the center area of the hybrid battery pack 20 and they are surrounded by a plurality of the high K-value battery cells 22. Each of the plurality of high K-value battery cells 22 and the plurality of low K-value battery cells 24 can be further separated into modules divided from each other by a series of structural members 26. The structural members 26 may also include cooling features. These structural members 26 can comprise cooling features such as passive heat sink materials that passively absorb heat from the battery cells 22, 24. Alternatively, the hybrid battery pack 20 can be cooled by air flow over the battery cells 22, 24 either through convection or via a forced air flow wherein fans (not shown) force air over the battery cells 22, 24 to cool them. The air flow may be forced through air flow channels, not shown, in the structural members 26. While air flow is relatively inexpensive as a cooling method it may not be sufficient for high power applications or in instances wherein there is limited space for air flow. A more efficient cooling of the hybrid battery pack can be achieved using a liquid cooling system. In such a system the structural members 26 may include a series of channels or pipes (not shown) that allow a fluid to circulate around the battery cells 22, 24 with the liquid flow acting to remove heat from the battery cells 22, 24. The liquid could comprise, for example, water, a water and glycerol mixture, mineral oil, or fluorinated ethers. The liquid cooling systems are more effective at cooling than air flow and allow for more precise temperature control; however, they are more expensive, more complex, and require more components including heat pumps and external heat exchangers and they pose the risk of leaks. Additional thermal management can be achieved by grouping the battery cells 22, 24 as modules and separating them into compartments by adding additional structural members 26. These design features can help increase pack strength and prevent battery cell overheating, thermal runaway, and thermal propagation thereby ensuring the longevity and safety of the hybrid battery pack 20.

In forming the hybrid battery pack 20 it is preferable that the low K-value battery cells have a positive K-value that is 50% or less of the K-value of the high K-value battery cells. As shown in Table 1, the NMC/Lithium battery cells had a low K-value of 0.576, which is 42.85% of the high K-value of the NMC/graphite battery cells of 1.344. The anode-free battery cells had a K-value of 0.528, which is 39.28% of the K-value of the high K-value NMC/graphite battery cells. As noted, the high K-value battery cells, forming the primary battery, are used during daily operations and it is preferable that these battery cells forming the primary battery can be discharged in the range of from 0 to 100% of the state of charge (SOC) during daily operations. The emergency battery formed from the low K-value battery cells preferably has a gravimetric energy density of 300 Wh/kg or greater and has a higher gravimetric energy density than the primary battery. As shown in Table 1 the NMC/Lithium battery cells and the NMC/anode-free battery cells have energy densities that are well above 300 Wh/kg at 430 Wh/kg and 500 Wh/kg respectively. For both high K-value battery cells and low K-value battery cells the cathode material can be selected from well-known cathode materials including, for example: lithium nickel cobalt aluminum oxide (NCA); lithium nickel manganese cobalt oxide (NMC); lithium iron phosphate; layered structures of lithium and metal oxides; spinel forms of lithium and metal oxides; olivine forms of lithium metal oxides; cation-disordered rocksalt (DRX) materials; lithium and mixed metal phosphates; and mixtures thereof. As known by those of skill in the art the DRX cathodes have a general formula of LiₓTM₍₂₋ₓ₎O₂, wherein TM represents one or more transition metals from groups 3 to 12 of the Periodic Table and 0≤x<2. Some examples of DRX cathodes include Li_{1.25}Nb_{0.25}Mn_{0.5}O₂; Li_{1.25}Ti_{0.4}Fe_{0.4}O₂; Li_{1.2}Ti_{0.4}Mn_{0.4}O₂; and Li_{1.25}Nb_{0.25}V_{0.5}O₂. For the primary battery the high K-value battery cells preferably have an anode material comprising graphite, hard carbon, soft carbon, silicon, silicon oxide, lithium titanium oxide and mixtures thereof. The emergency battery low K-value battery cells preferably have an anode material comprising lithium metal, anode-free designs and mixtures thereof. The current collectors used in the anode-free battery cells preferably comprise for example copper, titanium, aluminum, nickel stainless steel and mixtures thereof.

Balancing the battery cells within a battery pack is crucial for optimizing performance, longevity, and safety, especially when using two types of battery cells with different operational requirements. For high K-value battery cells used in daily operation, a high-frequency battery cell balancing strategy is employed, integrating active balancing circuitry within a battery management system (BMS) that continuously monitors and adjusts the individual battery cell voltages in real-time when the aircraft is in use. By a high-frequency battery cell balancing strategy it is meant that the BMS monitors each battery cell in the high K-value part of the hybrid battery pack at least every 5 seconds. Battery management systems, as known to those of skill in the art, are electronic control circuits that monitor and regulate the charging and discharging of the battery. This includes monitoring a variety of parameters of the battery cells in the battery including parameters such as voltages, temperature, capacity, SOC, power consumption, remaining operating time, and charging cycles. The goal of the BMS is to ensure optimal use of the energy in a battery and includes in multi-cell batteries a cell balancing function to ensure all the battery cells have a similar SOC. For the high K-value battery cells the BMS must be active and continuous while the aircraft is in use to ensure that the primary battery and its battery cells remain healthy and able to carry out the daily functions. This real time BMS approach ensures optimal performance by rapidly redistributing excess charge across the high K-value battery cells, maximizing usable capacity and extending lifespan. Conversely, for low K-value battery cells designated for emergency backup, a low-frequency cell balancing method can be applied, either through passive balancing or periodic checks during maintenance intervals. For example, the BMS for the low K-value battery cells may be activated only periodically by a user querying the BMS for the statistics for the low K-value battery cells. This simplified approach prioritizes battery cell preservation and reliability, avoiding unnecessary cycling to maintain readiness when needed. Together, these strategies offer tailored BMS balancing solutions for each battery cell type, optimizing both daily performance and emergency backup capabilities within the hybrid battery pack.

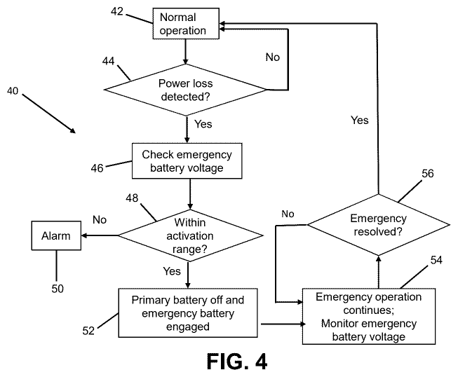

During emergencies when the emergency battery with the low K-value battery cells needs to be used, specific voltage control protocols are pivotal for activating the emergency battery, ensuring seamless transition and reliable power supply. An example flow chart detailing this process is shown at 40 in FIG. 4. The process has in step 42 normal daily operation. In this mode the primary batteries are being used for the daily needs. In step 44 the process determines if a power loss has been detected, if not it resumes normal operation, if power loss is detected the process moves to step 46 and checks the voltage of the emergency battery using the BMS system. If the emergency battery is within the predefined activation voltage range the process proceeds to step 52 and the switchover to the emergency battery is accomplished. In the switchover the primary battery is shut off and the emergency battery is engaged to deliver power to the electrical systems of the aircraft. This transition is carefully managed to maintain voltage stability, preventing voltage spikes or drops that could damage sensitive equipment. Throughout the emergency operation, the BMS continuously monitors the emergency battery's battery cell voltages, adjusting charging and discharging rates as needed to sustain power supply until normal operations can be restored. If the emergency battery is not within the activation voltage the process proceeds to step 50 and sounds an alarm. Once step 52 has been competed the process moves to step 54 wherein the emergency power generation system is engaged and the voltage of the emergency battery cells continues to be monitored. The process periodically queries whether the emergency has been resolved as shown in step 56. Once the emergency is resolved the process returns to step 42. After the emergency is resolved, the BMS initiates a controlled transition back to the primary battery, ensuring a smooth return to standard operation while maintaining system stability and integrity. By implementing these specific voltage control protocols, the emergency battery can be activated effectively during emergencies, providing reliable power support when needed most. If the emergency is not resolved the process continues in step 54.

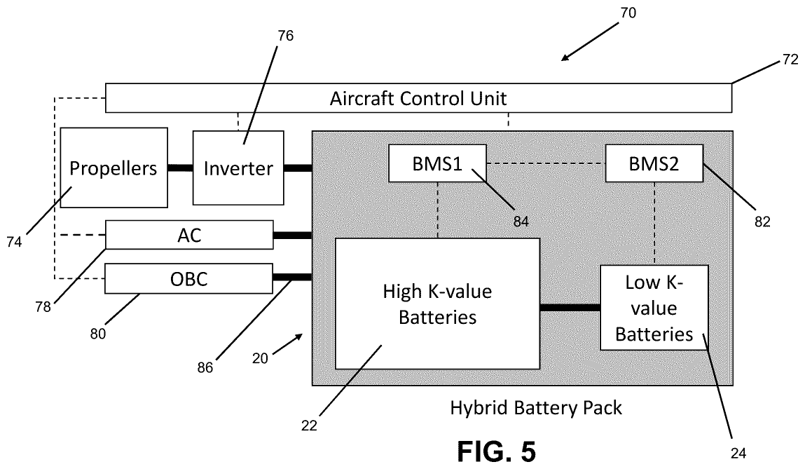

A powertrain for an aircraft with a hybrid battery pack 20 according to the present disclosure is shown schematically at 70 in FIG. 5. The high K-value 22 and low K-value 24 batteries are parallelly integrated and are preferably controlled by separate battery management systems, BMS1 84 and BMS2 82, although it is possible to control both utilizing an integrated BMS that controls both types of cells if desired. Aircraft electrical components, such as an inverter 76, an air conditioning (AC) system 78, and an on board charger (OBC) are connected to the hybrid battery pack 20 directly. For a fully electric aircraft the propellers 74 are powered through the inverter 76 by the primary high K-value 22 and the emergency low K-value batteries. In an aviation fueled aircraft this connection would not be present. All the signal communications are managed by an aircraft control unit 72. Bold lines 86 indicate the high voltage connections between the components.

The hybrid battery pack 20 design offers a balanced approach that maximizes performance, reliability, and cost efficiency by leveraging specialized battery cell types for their intended purposes. By tailoring the hybrid battery pack 20 configuration to address both daily operation and emergency backup needs, the hybrid battery pack 20 achieves optimal functionality while minimizing maintenance efforts and cost implications.

The foregoing disclosure has been described in accordance with the relevant legal standards, thus the description is exemplary rather than limiting in nature. Variations and modifications to the disclosed embodiment may become apparent to those skilled in the art and do come within the scope of the disclosure. Accordingly, the scope of legal protection afforded this disclosure can only be determined by studying the following claims.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

We claim:

1. A hybrid battery pack for an aircraft, comprising:
a primary battery comprising a first plurality of battery cells having a first K-value; and
an emergency battery comprising a second plurality of battery cells having a second K-value, wherein the second K-value is less than the first K-value.

2. The hybrid battery pack according to claim 1, wherein the second K-value is 50% or less than the first K-value.

3. The hybrid battery pack according to claim 1, wherein the primary battery provides electrical power to the aircraft during normal operation and wherein the emergency battery provides electrical power to the aircraft following loss of electrical power from the primary battery.

4. The hybrid battery pack according to claim 1, wherein the first plurality of battery cells can be discharged in the range of 0 to 100% state of charge (SOC).

5. The hybrid battery pack according to claim 1, wherein the second plurality of battery cells have a gravimetric energy density of at least 300 Wh/kg.

6. The hybrid battery pack according to claim 1 wherein the first and second plurality of battery cells each have a cathode electrode selected from the group consisting of lithium nickel cobalt aluminum oxide (NCA); lithium nickel manganese cobalt oxide (NMC); lithium iron phosphate; layered structures of lithium and metal oxides; spinel forms of lithium and metal oxides; olivine forms of lithium and metal oxides; cation-disordered rocksalt (DRX) materials; lithium and mixed metal phosphates; and mixtures thereof.

7. The hybrid battery pack according to claim 1 wherein the first plurality of battery cells each have an anode material selected from the group consisting of graphite, hard carbon, soft carbon, silicon, silicon oxide, lithium titanium oxide and mixtures thereof; and
wherein the second plurality of battery cells each have an anode material selected from the group consisting of a lithium metal, an anode-free design, and mixtures thereof.

8. The hybrid battery pack according to claim 1 wherein the second plurality of battery cells are located in a central area of the hybrid battery pack and are surrounded by the first plurality of battery cells.

9. The hybrid battery pack according to claim 8 wherein the first and second plurality of battery cells are each grouped into a plurality of modules and the plurality of modules are separated from each other by structural members.

10. The hybrid battery pack according to claim 9, wherein the structural members include cooling features that cool the hybrid battery pack.

11. The hybrid battery pack according to claim 10, wherein the cooling features include forming the structural members to include heat sink materials.

12. The hybrid battery pack according to claim 10, wherein the cooling features include a liquid flow to cool the hybrid battery pack.

13. The hybrid battery pack according to claim 10 wherein the cooling features include air flow.

14. The hybrid battery pack according to claim 1 wherein the first plurality of battery cells is controlled by a first battery management system having a high frequency battery cell balancing strategy and the second plurality of battery cells is controlled by a second battery management system that is different from the first battery management system.

15. The hybrid battery pack according to claim 14 wherein the first battery management system is continuously active during use of the aircraft.

16. The hybrid battery pack according to claim 14 wherein a frequency of monitoring of the first battery management system is at least every five seconds during use of the aircraft.
